(19) United States
(12) Patent Application Publication
(10) Pub. No.: US 2023/0163709 A1
(43) Pub. Date: May 25, 2023

(54) METHOD FOR SENSORLESS CURRENT PROFILING IN A SWITCHED RELUCTANCE MACHINE

(71) Applicant: Turntide Technologies Inc., Sunnyvale, CA (US)

(72) Inventors: Jacob Bayless, Vancouver (CA); Nicholas Nagel, Woodinville, WA (US)

(21) Appl. No.: 17/917,829

(22) PCT Filed: Apr. 8, 2021
(86) PCT No.: PCT/US2021/026434

§ 371 Date: Oct. 7, 2022

Related U.S. Application Data
(60) Provisional application No. 63/007,290, filed on Apr. 8, 2020.

(51) Int. Cl. H02P 25/089; H02P 25/098; H02P 6/18

(52) U.S. Cl. CPC H02P 25/089; H02P 25/098; H02P 6/18; H02P 2203/01

(57) ABSTRACT

A method and an apparatus for sensorless profiling of a current waveform in a switched-reluctance motor (SRM) is disclosed. The apparatus comprises a switched-reluctance motor having at least one stator pole and at least one rotor pole, a phase inverter controlled by a processor, a load, a converter and a software control module at the processor. The current waveform sets a target magnitude for a programmable dwell angle that scales a programmable waveform shape. Slope of the current is continuously monitored which allows the shaft speed to be updated multiple times and to track any change in speed and fix the dwell angle based on the shaft speed. The method reduces the overall radial force magnitude by compensating nonlinear torque production thereby reducing the acoustic noise reduction and torque ripple which results in computational efficiency of the SRM.

### RELATED APPLICATIONSD

This application claims priority from the U.S. provisional application with Ser. No. 63/007,290, which was filed on Apr. 8, 2020. The disclosure of that provisional application is incorporated herein as if set out in full.

### BACKGROUND OF THE DISCLOSURE

### Technical Field of the Disclosure

The present disclosure relates generally to switched reluctance machines, and more particularly to a sensorless switched-reluctance motor control system and method for profiling a current waveform based on turn-on time and turn-off time of the current waveform for optimizing computational efficiency.

### Description of the Related Art

A switched reluctance machine (“SRM”) is a rotating electric machine having salient poles in both stator and rotor. SRMs may operate as either a generator or a motor, and are gaining wider reputation in industrial applications due to their high level of performance ability, insensitivity to high temperature, and their simple construction. An SRM possesses high speed operating ability and has become a viable alternative to other conventional drive motors. For an SRM, the stator has a centralized winding system comprising multiple phases, unlike the rotor which is unexcited and has no windings or permanent magnets mounted thereon. The stator coils are fed frequently and sequentially from a DC power supply, and thus generate electromagnetic torque. A pair of diametrically opposed stator poles produces torque in order to attract a pair of corresponding rotor poles into alignment with the stator poles. As a consequence, this torque produces movement in a rotor of the SRM. The rotor of an SRM is formed of a magnetically permeable material, typically iron, which attracts the magnetic flux produced by the windings on the stator poles when current is flowing therethrough. The magnetic attraction causes the rotor to rotate when excitation to the stator phase windings is switched on and off in a sequential fashion in correspondence to the rotor position.

In conventional SRMs, a shaft angle transducer, such as an encoder or a resolver, generates a rotor position signal and a controller reads this rotor position signal. The addition of this device increases the cost and decreases the reliability of the SRM. Also, the high degree of ripples in its output torque causes increased acoustic noise generation from the SRM. The torque and speed of the SRM can be controlled accurately only by exciting the phase windings at appropriate instants in accordance with the rotor position. However, to overcome these issues, several sensorless SRMs have been developed in which the period of conduction of the phase winding influences the torque production significantly. Improvements involving dwell angle are being developed as well. An optimum dwell angle should give minimum or zero value of negative torque in each phase so that the overall torque has minimum pulsations in the SRM drive.

Another approach describes a system and method for achieving sensorless control of SRM drives using active phase voltage and current measurements. These sensorless systems and methods generally rely on a dynamic model of the SRM drive. Active phase currents are measured in real-time and, using these measurements, the dynamic equations representing the active phases are solved through numerical techniques to obtain rotor position information. The phase inductances are represented by a Fourier series with coefficients expressed as polynomial functions of phase currents to compensate for magnetic saturation. This system teaches the general method for estimating rotor position using phase inductance measured from the active phase. Here, they apply voltage to the active phase and measure the current response to measure position. This current magnitude is kept low to minimize any negative torque generated at the shaft of the motor.

Conventional SRMs often exhibit unacceptable levels of noise and vibration due not only to their failure to obtain varying torque curves from the SRM, but also the fact they are driven by rectangular-shaped waveforms. The performance may be tuned by optimizing the turn-on angles, turn-off angles, and current amplitude as functions of speed and torque. The prior art has shown this can yield very good performance in terms of efficiency and power density, and is simple to program and optimize, but due to the conventional SRMs high nonlinear functionality between the current, rotor angle, torque, and radial forces, the rectangular waveform may not be optimal in every aspect. One particular quality for optimization is acoustic noise, which is long acknowledged as a challenge for SRMs. A particular cause of acoustic noise in SRMs is radial attraction between the stator and rotor salient poles. Current is injected into a stator coil to produce torque by attracting a salient rotor pole toward it in the tangential direction, a small amount of radial attraction is also produced. However, as the rotor pole comes into alignment with the stator pole, the radial attraction force between the two increases rapidly. This variation in radial force induces vibrations in the stator which transfer into the stator housing and radiate as acoustic noise, especially when the excitation matches a structural resonance mode.

Yet another approach discloses a sensorless rectangular waveform usually designed as a function of rotor angle. Their frequency content will scale with speed, although sometimes they are designed as a function of time. The waveforms may be optimized offline and then stored in firmware, or calculated in real-time by the motor controller, even adapting in response to a feedback signal from a microphone or accelerometer which adds to system cost and complexity. Generally, a waveform must be specifically tuned for a particular motor model's electromechanical characteristics, and the optimal profile might vary with speed or load. Furthermore, the existing sensorless code uses measured rate of change of current to estimate inductance at a specific “anchor” point to determine if the existing phase has been turned-on at the optimal time. From the anchor point, a timer-based software encoder is used to regulate current to a constant value and when to turn it off. However, this method is only capable of utilizing rectangular waveform and is not extended to other waveform profiles. Furthermore, the radial force is not controlled in this method which increases acoustic noise.

In light of the teachings and disclosures of the totality of prior art, there remains a need for a sensorless switched-reluctance motor control system and method for profiling a current waveform. This method would provide an anchor point for control of the turn-on for a given phase current, but then would use a non-constant current profile to optimize performance based on desired criteria. Moreover, this method would alter the shape of the drive waveform from a rectangular profile so that the current would gradually reduce as the rotor and stator poles enter into alignment. Similarly, this would reduce or prevent the radial force increase that would otherwise happen, reducing the acoustic noise. Variations on the technique would employ different waveform profiles to reduce torque ripple, enhance efficiency, or optimize some balance of such performance targets. Such a needed method would provide in at least one case the desired waveform in polynomial series based on Chebyshev polynomials to obtain computational efficiency and real time adjustability. Other techniques may include look-up tables, Fourier series, or other suitable techniques for determining the desired waveform. Further, this approach would be associated with a control algorithm that would not need to be calibrated for all motor specifications and power ratings. Such a needed method would reduce the overall radial force magnitude and reduce torque ripple by compensating nonlinear torque production. Moreover, this method would combine waveform profile with sensorless operation at low cost. Such a system would be simple, efficient, and easy-to-use. The present embodiment overcomes shortcomings in the field by accomplishing these critical objectives.

### SUMMARY OF THE DISCLOSURE

To minimize the limitations found in the prior art, and to minimize other limitations that will be apparent upon the reading of this specification, the present invention provides a method and apparatus for sensorless profiling of a current waveform in a switched-reluctance motor (SRM).

The method comprises the steps of: providing a sensorless switched-reluctance motor control system comprising a switched-reluctance motor having at least one stator pole and at least one rotor pole, a phase inverter controlled by a processor, a load, a converter and a software control module at the processor. Next, the system estimates a time-based rotor position at every commutation utilizing a time-based interpolation module at the processor, and then an optimum rise point at a turn-on time of the current waveform is determined. Next, the system estimates the required torque to maintain the operating speed. Next, the system calculates a target magnitude based on the estimated required torque, which scales the current waveform, such that the target phase current when varying according to the programmed waveform shape (and proportional to the target magnitude) achieves approximately the required torque to control a given speed. The dwell angle is adjusted based on the shaft speed and the required torque of the SRM. Next, the reference current varies according to the waveform shape, which is a determined function of the time-based position estimate, scaled by the target magnitude.

The apparatus for sensorless profiling of a current waveform in a switched-reluctance motor (SRM), comprises a switched-reluctance motor having at least one stator pole and at least one rotor pole, a phase inverter controlled by a processor and connected to the switched-reluctance motor to provide power supply to the SRM, a load connected to the switched-reluctance motor via an inline torque meter and a converter connected to the load. The processor has a software control module and a time-based interpolation estimation module. The time-based interpolation module estimates a position of the rotor and the software control module at the processor determines the shape of the current waveform to produce adequate torque required to maintain the motor operating speed and thereby reduces acoustic noise, torque ripple and increases efficiency utilizing a non-constant current profile.

The rotor poles of the SRM are rotationally related to a motor shaft that optionally comprises a magnetic sensor. The three-phase inverter is adaptable to act as a power supply to the switched-reluctance motor, the processor having the software control module and the time-based interpolation module.

A first objective of the present invention is to provide a sensorless switched-reluctance motor control system and method for profiling a current waveform based on turn-on time and turn-off time of the current waveform for optimizing computational efficiency.

A second objective of the present invention is to provide a method that delivers an anchor point for control of the turn-on time for a given phase current, but then uses a non-constant current profile to optimize performance based on preferred standards.

A third objective of the present invention is to provide a method that alters the profile of the drive waveform which reduces torque ripple, enhances efficiency and optimize performance targets.

A fourth objective of the present invention is to provide a method that programs the desired waveform in a polynomial series based on the Chebyshev polynomial to obtain computational efficiency and real time adjustability.

Another objective of the present invention is to provide a method that reduces the overall radial force magnitude and reduces the torque ripple by compensating nonlinear torque production.

Still another objective of the present invention is to provide a method that combines the waveform profile with sensorless operation at low cost, is efficient and easy-to-use.

These and other advantages and features of the present invention are described with specificity so as to make the present invention understandable to one of ordinary skill in the art.

### BRIEF DESCRIPTION OF THE DRAWINGS

In order to enhance their clarity and improve understanding of these various components and embodiments of the invention, elements in the figures have not necessarily been drawn to scale. Furthermore, elements that are known to be common and well understood to those in the industry are not depicted in order to provide a clear view of the various embodiments of the invention. Thus, the drawings are generalized in form in the interest of clarity and conciseness.

FIG. 1 illustrates a flow chart of a method for sensorless profiling of a current waveform in a switched-reluctance motor (SRM) in accordance with the preferred embodiment of the present invention;

FIG. 2 illustrates a block diagram of an apparatus for a sensorless control of the switched-reluctance motor (SRM) in accordance with the present invention;

FIG. 3 is a graph illustrating a family of waveforms of equal torque of the switched-reluctance motor in which the waveform is programmed in polynomial series based on Chebyshev polynomial in accordance with the preferred embodiment of the present invention;

FIG. 4 is a graph illustrating an oscilloscope captured square waveform profile programmed in polynomial series in accordance with the preferred embodiment of the present invention;

FIG. 5 is a graph illustrating an oscilloscope captured custom shaped waveform programmed in polynomial series in accordance with the preferred embodiment of the present invention;

FIG. 6 is a graph illustrating another oscilloscope captured custom shaped waveform programmed in polynomial series in accordance with the preferred embodiment of the present invention;

FIG. 7 is a graph illustrating an oscilloscope captured data displaying acoustic noise reduction due to waveform profiling in accordance with the preferred embodiment of the present invention; and

FIG. 8 is a graph illustrating efficiency gain due to waveform profiling in accordance with the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized, and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term ‘about” means +/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description is based in reference for use with a rotary switched reluctance motor, which has a commonly known form with a wound stator and an internal rotor with salient poles and a radial airgap. However, the method is not exclusive to a particular motor geometry, and may apply equally well to linear motors, rotary motors, external rotor motors, internal rotor motors, multiple-stator motors, axial motors, motor generators or generators relating to any of the above, and other well-known variations.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

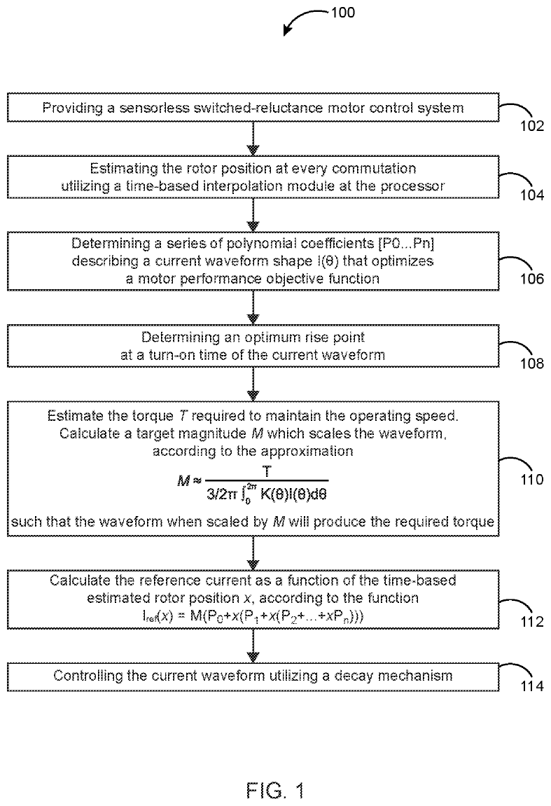

Referring to FIG. 1, a flow chart of a method for sensorless profiling of a current waveform in a switched-reluctance motor (SRM) 100 in accordance with the present invention is illustrated. The method 100 described in the preferred embodiment combines the waveform profile with sensorless operation. The method 100 described in the present embodiment reduces the overall radial force magnitude, reduces the torque ripple by compensating nonlinear torque production and increases efficiency by reducing peak flux in the machine at light loads. The method 100 provides an algorithm that delivers an anchor point for control of the turn-on time for a given phase current, but then uses a non-constant current profile to optimize performance based on preferred standards.

The method 100 is initiated by providing a sensorless switched-reluctance motor control system comprising a switched-reluctance motor having at least one stator pole and at least one rotor pole, a phase inverter controlled by a processor, a load, a converter and a software control module at the processor as indicated at block 102. Next, estimating a time-based rotor position estimate at every commutation utilizing a time-based interpolation module at the processor, as shown in block 104. Thereafter, a series of polynomial coefficients [P₀ . . . Pₙ] describing a current waveform shape I(θ) that optimizes a motor performance objective function is determined as indicated at block 106.

Next, as indicated at block 108, the method determines an optimum rise point at a turn-on time of the current wave form, and estimates the torque T required to maintain the operating speed as indicated at block 110. The method then calculates a target magnitude M, which scales the waveform, while the target phase current will vary according to the programmed waveform shape (and proportional to the target magnitude), such that the resulting current produces approximately the required torque. The necessary magnitude M is calculated approximately by the equation

$$M \approx \frac{T}{\frac{3}{2 π} {\int }_{n}^{2 n} K ( θ ) I ( θ ) d θ}$$

as shown in block 110. Next, the reference current varies according to the waveform shape, which is a determined function of the time-based position estimate, scaled by the target magnitude as shown in block 112. The reference current is calculated as a function of the time-based estimated rotor position x by the function I_{ref}(x)=M(P₀+x(P₁+x(P₂+ . . . +xPₙ))). Thereafter, controlling the current waveform utilizing a decay mechanism as indicated at block 114.

The method 100 utilizes a non-constant current profile to optimize performance based on desired criteria. This method 100 allows control of waveform profiles of an arbitrary shape. The current is reduced to zero using a decay mechanism following the end of the dwell angle. The desired waveform shape in the dwell region is programmed as a polynomial series based on Chebyshev polynomials.

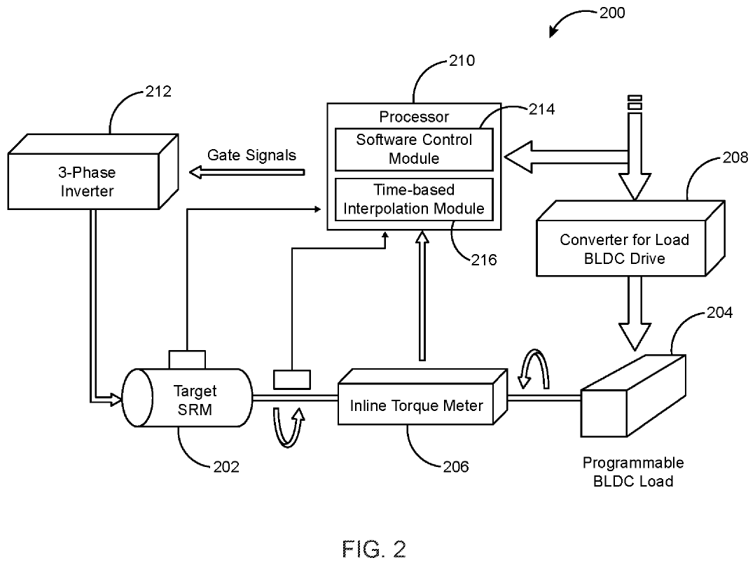

In the preferred embodiment, as shown in FIG. 2, an apparatus 200 for sensorless current profiling of the switched-reluctance motor (SRM) 202 is provided. The apparatus 200 comprises a sensorless switched-reluctance motor 202 having at least one stator pole and at least one rotor pole, a phase inverter 212 controlled by a processor 210, a load 204 and a converter 208. The processor 210 includes a software control module 214 and a time-based interpolation module 216. The software control module 214 creates a control algorithm that uses a time-based interpolation estimate for rotor position, updated at every commutation. The time-based interpolation module 216 estimates a position of the rotor and the control algorithm of the software control module 214 determines the shape of the current waveform. The phase inverter 212 is controlled by the processor 210 and is connected to the switched-reluctance motor 202 to provide power supply to the SRM 202.

The apparatus 200 includes a programmable brushless direct current load 204 that may optionally be connected to the output of the switched-reluctance motor 202 via an inline torque meter 206 and the converter 208. The software control module 214 of the control processor 210, establishes a firm time base on the optional magnetic sensor. The software control module 214 regulates the current to a constant value and signals when to turn off the current. The rotor produces an inductance profile in each of the stator poles as each of the rotor poles comes into and out of alignment with the stator poles when the rotor is rotated.

The sensorless control of the switched-reluctance motor (SRM) 202 naturally calibrates the control algorithm to the inductance profile of the switched-reluctance motor 202. The SRM 202 is scalable to all power levels and the creation of the control algorithm does not have to be calibrated for all motor specifications and power ratings. The switched-reluctance motor 202 can automatically accommodate for motor-to-motor or process variations.

In the preferred embodiment, the software control module 214 at the processor 210 is programmed with current waveform shaping control in order to reduce acoustic noise, torque ripple and to enhance the overall efficiency of the SRM 202. By altering the shape of the drive waveform from a rectangular profile to a different custom shape waveform(s), the current reduces gradually as the rotor and stator poles enter into alignment. This reduces the radial force magnitude which in turn reduces the acoustic noise. Variations on the technique may employ different waveform profiles to reduce torque ripple, enhance efficiency and optimize performance targets. The waveform is tuned for a particular motor's electromechanical characteristics using motor controllers, and the optimal profile is varied with speed or load. Waveforms are usually designed as a function of rotor angle that their frequency content will scale with speed, but they may also be designed as a function of time.

In the prior art, the SRM adjusts the turn-on angle automatically so that the current reaches its target amplitude at the desired mechanical angle, almost independent of speed, load and bus voltage to obtain a standard rectangular current waveform. In the preferred embodiment, the control algorithm of the software control module 214 has been expanded to support the control of waveform profiles of nearly any shape.

The preferred method 100 utilizes the time-based interpolation module 216 at the processor 210 to estimate the rotor position at every commutation thereby determining an optimum rise point at the turn-on time of the current waveform. A large space of near-optimal (from a noise perspective) waveforms requires a fast rise at the turn-on time, regardless of the shape of the remaining current profile. This is due to the turn-on angle occurring close to the point where the SRM 202 attains the maximum ratio between torque and radial force, as the rotor teeth are misaligned. As the lowest radial forces are produced in this region, a high current in this region excites less noise and vibration for a given torque output. Furthermore, the motor inductance is near its minimum at this point, so the effective back-EMF is low in this region even at high speeds.

In this method 100, the desired waveform shape in the dwell region is programmed as a polynomial series based on Chebyshev polynomials. Other perhaps more computationally intensive techniques may be employed as well, such as look up tables or the use of Fourier transforms. The waveform profiling can also be programmed similarly in a lookup table or a Fourier series. But polynomial series based on Chebyshev polynomials has been found to offer a very practical balance of computational efficiency, real-time adjustability, and ability to closely approximate any desired function.

In use, even a 3^{rd} order polynomial has been found sufficient to achieve a wide range of desired current profiling goals.

The polynomials may be implemented in real-time in the form:

I(x)=I_{ref}(P₀+x(P₁+x(P₂+x( . . . x(Pₙ₋₁+xPₙ)))))

where the time-based angle estimate, x, is used as the primary input for the waveform profile. x is scaled so that it ranges linearly from 0 at the start of the dwell region to 1 at the end of the dwell region, where the current will usually be turned off. Time-based current profiling can be implemented equally effectively by using the unscaled time value t in place of x, and can be combined with position-based profiling by superimposing the result. The dwell region is the turn-on point, in which current in the motor produces positive torque (in an SRM, the angles over which the inductance is increasing as the salient poles come into alignment). It can be approximately considered to be 120 electrical degrees, although this will vary depending on the particular motor design. This is the region where, for a square waveform, the current would be applied to the coil. In practice, some benefits may be gained by applying current for more than or less than the entire dwell period. In other practical instantiations that produce equivalent results, x ranges from −1 to 1, or from −1 to 0, from 0 to 1024, etc., by simple modifications to the procedure.

The coefficients [P₀ . . . Pₙ] are calculated to approximate any desired waveform. One effective method is by first representing the desired waveform using Chebyshev polynomial approximation. This approach minimizes the maximum error over the domain of the function. Then the Chebyshev polynomial coefficients may be expanded to calculate [P₀ . . . Pₙ], to reduce computation time. For example, if P₀=1 and P₁ . . . Pₙ=0, then this method reproduces a square wave.

In this method 100, the waveform shaping is done outside of the dwell period, in which the current waveform is controlled to track a particular reference value throughout a greater portion of the electrical period, or the entire electrical period, rather than turned completely off at the end of the dwell cycle. The reason for doing this is, due to voltage limits, it is not possible to turn off the current completely at a given torque and speed, which is known as continuous conduction mode. Also, some secondary performance improvements can be attained by supplying additional current outside of the torque-producing dwell region where the current is traditionally turned off, for example, control of radial force for the purpose of noise or vibration reduction, or mitigation of torque ripple, or for obtaining diagnostic information relating to phase inductance, resistance and motor speed through system identification techniques. This method 100 is extended with illustrative examples as follows:
a. The variable can be mapped to a wider domain. For example, it may range from 0 at the turn-on period to 1 at the following turn-on period. This typically will require a higher-order polynomial expression to achieve sufficient fidelity over this wider domain. For example, if a 3^{rd} order polynomial was used where ‘x’ ranged from 0 to 1 over the dwell cycle, then a 6^{th} order polynomial may be needed when x ranges from 0 to 1 over the full lo electrical period.
b. The domain can be split into sub-domains, each with a different expression for the waveform shape in that sub-domain. For example, a polynomial I₁(x₁) may be used where x₁ is defined for 0<θ<2π/3; and then I₂(x₂) where x₂ is defined for 2π/3<θ<4π/3; I₃(x₃) over the turn-on region for 4π/3<θ<2π. The order of each polynomial I₁, I₂, . . . may be different, depending on the requirement for current fidelity in that region. In fact, in principle each sub-domain could even have a completely different method of defining the target current, such as a polynomial a first region, a lookup table in a second region, and a Fourier series in a third region. These region boundaries may be designed as a function of operating speed or torque, or adjusted during operation by a feedback loop.

The primary restriction on all of the above is that, in accordance with the sensorless operation principle, voltage must be applied at a turn-on point at each commutation, in order to measure a rate of change of current to determine the instantaneous coil inductance and update the estimates of rotor angle and speed. The traditional square wave approach implies that the nominal current was set to zero prior to the turn-on angle being reached; however, with waveform shaping, the nominal current may deliberately be nonzero prior to this turn-on point. In this context it might be better considered a “measurement turn-on point” rather than a “voltage turn-on point”.

The waveform can be expressed in the Chebyshev polynomial basis directly. This achieves higher numerical accuracy at the cost of some additional computation time. Chebyshev polynomials are a powerful tool for approximating any desired function. Similar to a Fourier series, the first few terms define the general shape of the function, and higher-order terms add in finer resolution details. Their use is predominantly due to the fact that the error between any desired smooth continuous function F, and a Chebyshev polynomial of order ‘n’, will be well-approximated (minimize maximum error) by the Chebyshev polynomial term of order ‘n+1’. As polynomials can be rapidly executed on a microprocessor with multiply-and-accumulate functions, the Chebyshev polynomials provide a minimal-order polynomial approximation to arbitrary F with low memory and computation overhead. The Chebyshev polynomials are defined as

### T₀(x)=1

### T₁(x)=x

Tₙ(x)=2xTₙ₋₁(x)−Tₙ₋₂(x)
For example, for a 3rd-order polynomial:
If I(x)=C₀T₀(x)+C₁T₁(x)+C₂T₂(x)+C₃T₃(x)
And I(x)=P₀+P₁x+P₂x²+P₃x³
Then the coefficients Pₙ can be determined by substituting for Tₙ:
P₀=C₀−C₂
P₁=C₁−3C₃
P₂=2C₂
P₃=4C₃
For waveform approximation, the shifted polynomials Tₙ*, with a domain from 0 to 1, can be more convenient to use. They are defined as Tₙ*(x)=Tₙ(2x−1).
For example, for a 3^{rd} order polynomial:
If I(x)=C₀*T₀*(x)+C₁*T₁*(x)+C₂*T₂*(x)+C₃*T₃*(X)
And I(x)=P₀+P₁x+P₂x²+P₃x³
Then the coefficients Pₙ may be determined by substituting for Tₙ*:
P₀=C₀*−C₁*+C₂*−C₃*
P₁=2C₁*−8C₃*+18C₃*
P₂=8C₂*−48C₃*
P₃=32C₃*
The use of Chebyshev polynomials is a practical implementation approach for this method.

In the preferred embodiment, the phase inverter 212 that supports unipolar currents, I(x), is bounded between 0 and the maximum instantaneous current. This computation can be efficiently executed on a digital signal processor (DSP) with very little computational burden. While a rectangular waveform is effectively controlled using slow-decay switching during the dwell period and fast-decay switching in the turn-off period. The custom shaped waveforms generally require a greater amount of control authority to track accurately. As a result, the current control using fast-decay or mixed-decay during the dwell period is recommended. The waveform may be effectively controlled using conventional feedback and feedforward techniques, such as PWM or hysteresis control. When high efficiency is needed, the waveform profiles will turn off the current in the negative torque (generating) region as quickly as possible, and leave it off until the next turn-on point. However, for other objectives such as acoustic noise suppression, torque ripple reduction, or ultra-high-speed operation, the current waveform is desirable to control a non-zero current in the generating region. This can easily be accomplished, either by extending the domain of the waveform profile through the generating region, or by switching to a second current profile shape that is active in the generating region. The only requirement for sensorless operation is that the current has a defined target point where slope can be compared with a nominal reference, in an area where the local inductance variation is linear enough to use as a feedback signal.

In many applications, the waveform profile will be fixed and not need to be adjusted during operation. However, this varies for different waveform profiles. One consideration is that when changing the current profile by changing the values of [P₀ . . . Pₙ], the torque output will generally be affected, potentially causing the motor to stall. One solution is to change the waveform slowly, allowing the motor control feedback loop sufficient time to adapt and stabilize the torque output. However, if fast changes are necessary, then I_{ref} can be proactively rescaled when the waveform shape is adjusted to maintain a steady output torque. Computing the exact value of I_{ref} that will maintain a perfectly consistent torque is quite difficult given the nonlinear behavior of an SRM; however, a rough approximation usually gives a close enough result for the motor controller's feedback loop to correct for the remaining disturbance.

An approximate model is as follows:

$$T ( I ( θ ) ) \approx \frac{3}{2 π} {\int }_{0}^{2 π} K ( θ ) I ( θ ) d θ$$

This integral can be solved exactly for K(θ) and I(θ) being polynomial functions of θ, including when I(θ) is bounded to be positive only, and the solution is also very cheap to compute on a DSP. While K(θ) is in general also a function of current for most SRMs, using an approximate value that is calculated close to the motor's nominal operating point yields results that are sufficiently accurate for most real-time control purposes. When the waveform shape is changed, the new I_{ref} is scaled to match the torque from the previous waveform shape.
The solution is as follows. First, it is divided into the regions R over which I(θ) is defined as distinct functions.

$$T ( I ( θ ) ) = {\sum }_{R} {T}_{R} ( {I}_{R} ( θ ) )$$

$${T}_{R} = \frac{3}{2 π} {\int }_{{R}_{-}}^{R +} {K}_{R} ( θ ) {I}_{R} ( θ ) d θ$$

For example, region 0 may be the ramp-up region where I(θ) is well-approximated by a linear function. Region 1 may be the dwell region, and so forth.
In each region R, K_{R}(θ) is represented as a polynomial function, and I_{R}(θ) is represented as a different polynomial function. Then:

$${K}_{R} ( θ ) = {\sum }_{K}^{mR} {KK}_{R , K} {θ}^{K}$$

$${I}_{R} ( θ ) = {\sum }_{J}^{nR} {I}_{R , j} {θ}^{j}$$

$${K}_{R} ( θ ) {I}_{R} ( θ ) = {\sum }_{K}^{nR + mR} {\sum }_{J}^{K} ( {K}_{R , j} {I}_{R , k - j} {θ}^{K} )$$

$${T}_{R} = \frac{3}{2 π} {\sum }_{K}^{nR + mR} {\sum }_{J}^{K} ( \frac{1}{k + 1} {K}_{R , j} {I}_{R , k - j} {θ}^{k + 1} ) {\vert}_{R -}^{R +} \vert$$

$${T}_{R} = \frac{3}{2 π} {\sum }_{k}^{n + m} {\sum }_{j}^{k} ( \frac{1}{k + 1} {K}_{R , j} {I}_{R , k - j} ( {R}_{+}^{k + 1} - {R}_{-}^{k + 1} ) )$$

This expression can be easily evaluated to estimate the torque. Generally, R+, R−, K, and the order of each polynomial are known at compile time, so this can be rapidly calculated for the polynomial coefficients of the current expression.

Thus, in the present method, after estimating the time-based rotor position estimate, a series of polynomial coefficients [P₀ . . . Pₙ] for describing a current waveform shape I(θ) is determined. The optimum rise point at a turn-on time of the current waveform is determined and the torque required to maintain the operating speed of the motor is calculated. The target magnitude M required to produce torque required to maintain a given speed is determined by the equation

$$M \approx \frac{T}{\frac{3}{2 π} {\int }_{n}^{2 n} K ( θ ) I ( θ ) d θ} .$$

Then setting the reference current I_{ref} at each time step in the dwell angle in accordance with the waveform shape and the time-based position estimate and scaled by the target magnitude. The reference current is calculated as a function of the time-based estimated rotor position x by the function I_{ref}(x)=M(P₀+x(P₁+x(P₂+ . . . ,+xPₙ)))

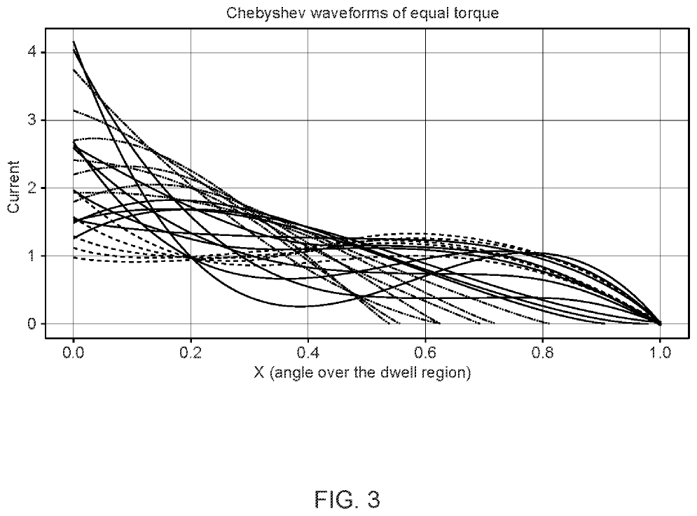

FIG. 3 illustrates a graph of a family of waveforms of equal torque of the switched-reluctance motor in which the waveform is programmed in polynomial series based on the Chebyshev polynomial. The graph shows various waveform shapes, which are achieved by different values of [P₀ . . . P₃], any of which will drive the motor with the same torque as a square waveform of magnitude 1.

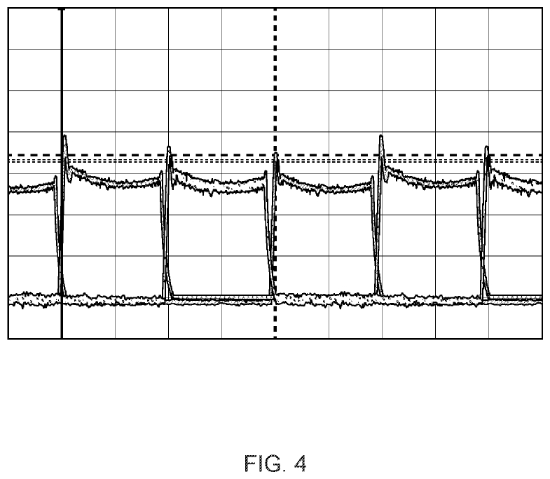

As shown in FIG. 4, an oscilloscope captured square waveform profile of the switched-reluctance motor, in which the waveform is programmed in polynomial series based on the Chebyshev polynomial with C₀*=1, C₁*=0, C₂*=0 and C₃*=0. This waveform illustrates the prior art of a conventional square (rectangular) waveform, and the fact that the polynomial method is flexible enough to reproduce it with a particular choice of coefficients.

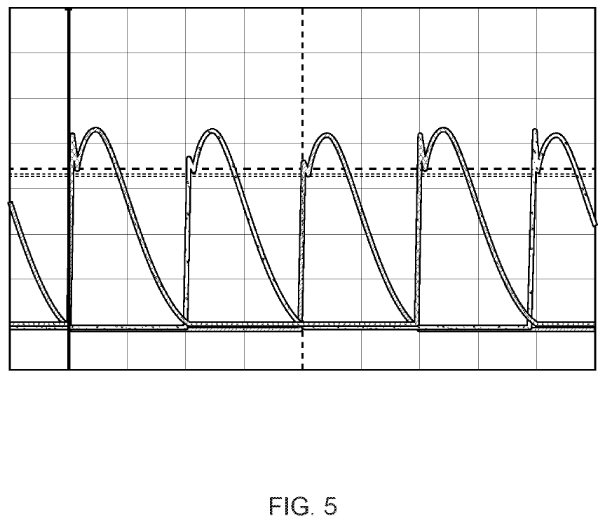

As shown in FIG. 5 an oscilloscope captured custom shaped waveform of the switched-reluctance motor, in which the waveform is programmed in polynomial series based on the Chebyshev polynomial with C₀*=1.2, C₁*=−0.7, C₂*=−0.2 and C₃*=0.2.

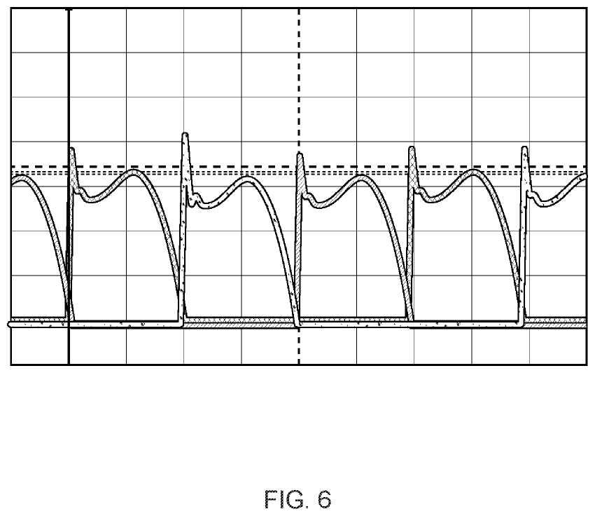

FIG. 6 illustrates an oscilloscope captured another custom shaped waveform of the switched-reluctance motor, in which the waveform is programmed in polynomial series based on the Chebyshev polynomial with C₀*=1.2, C₁*=−0.3, C₂*=−0.2 and C₃*=−0.2.

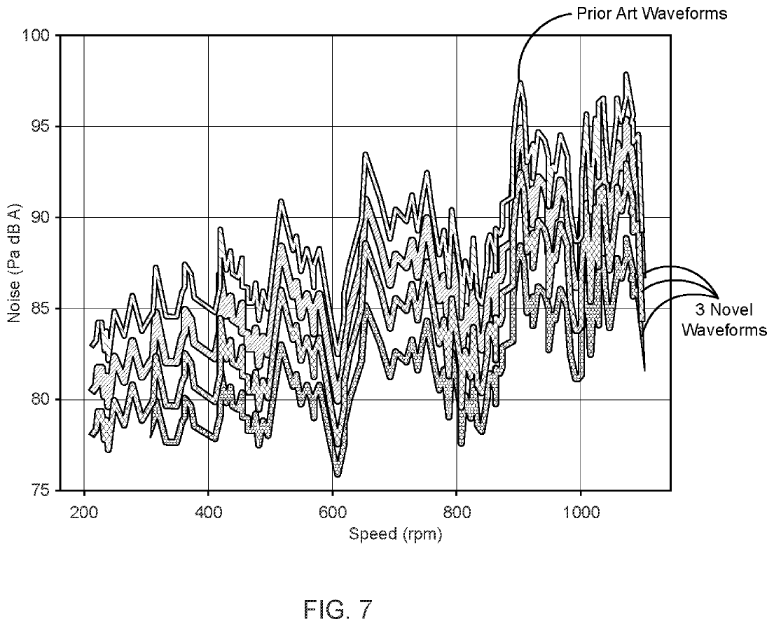

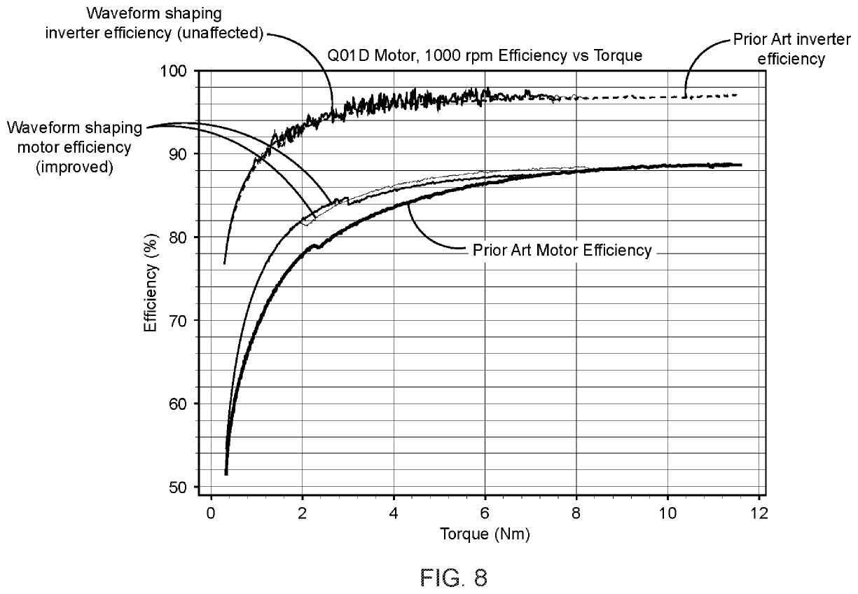

FIGS. 7 and 8 are graphs illustrating dynamometer captured data displaying acoustic noise reduction and efficiency gain due to waveform profiling respectively.

In the primary embodiment, the method for sensorless profiling of a current waveform in a switched-reluctance motor is applied to an already designed and constructed switched-reluctance motor and the optimal drive method is determined. In another alternative, the method is applied at the motor design stage, such that the motor control waveform is optimized together with the magnetic design at the same time. This results a poor performance in a traditional square waveform, but provides very high performance when driven with a custom shaped waveform.

In another embodiment, real-time waveform shaping with a feedback signal is employed. Here, in the case of a motor that has instrumentation available to measure performance quantities of interest in real time (such as a microphone or accelerometer for noise or vibration), a feedback algorithm could be developed where the drive waveform is modified “on the fly” in response to noise, vibration, or torque ripple measurements in a continuous process to drive the noise to a minimum value. Optionally, the waveform shaping extends into the generating region. In some cases, the system deliberately injects nonzero current outside of the dwell region to yield secondary benefits such as extra torque ripple reduction.

In the primary embodiment, the performance criteria such as efficiency, torque ripple, and noise are optimized. In rare cases, the optimal waveform for efficiency will also be the optimal waveform for torque ripple and will also be the optimal waveform for noise, but generally, these performance criteria are in conflict with one another. Optimization thus comes at a trade-off between different preferred performance criteria. In an alternative embodiment, the motor controller is programmed with a method of computing a performance score for a drive waveform, given a preference weighting over each performance criterion, the waveform can be varied automatically in response to a user preference. For example, if a user decides that noise is important during the day and efficiency is important at night, then the motor controller may select a waveform that maximizes a noise-weighted performance metric during the day, and an efficiency-weighted performance metric at night. Just like the waveform shaping itself, this can be achieved in many ways such as a lookup table, neural network, etc. One method would be a continuous function that maps the operating point (torque, speed), and waveform parameters C₀* . . . Cₙ* to a vector of performance scores Y₀ . . . Y_{Q}, which can then be maximized according to an objective function over that vector. The function could also be inverted such that the objective weightings and operating points map to waveform parameters.

In another embodiment, the method is applied to a switched-reluctance generator, or a motor operating in the generating mode, or a machine operating in four-quadrant mode (as both a motor and generator). Due to the well-understood symmetry between motor and generator applications, the described method may be extended to generator applications with few changes. The nonzero current is controlled in the generating region (where inductance is decreasing) rather than in the motoring region (where inductance is increasing). The torque produced would be in the direction opposite to the rotation. Optimal generator waveform shapes will approximately resemble time-reversed variations of the optimal motor waveform shapes. Position estimation may be based on the slope of the rising edge with a correction for the saturation effects, or advantageously, based on the slope of the falling edge of the current.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A method for sensorless profiling of a current waveform in a switched-reluctance motor (SRM), the method comprising the steps of:
a) providing a sensorless switched-reluctance motor control system comprising a switched-reluctance motor having at least one stator pole and at least one rotor pole, a phase inverter controlled by a processor, a load, a converter and a software control module at the processor;
b) estimating a time-based rotor position estimate at every commutation utilizing a time-based interpolation module at the processor;
c) determining a current waveform shape that is a function of the time-based position estimate;
d) determining an optimum rise point at a turn-on time of the current waveform;
e) setting a target magnitude for a programmable dwell angle to scale the current waveform as required to produce torque to control a given speed according to the equation
$$T ( I ( θ ) ) \approx \frac{3}{2 π} {\int }_{0}^{2 π} K ( θ ) I ( θ ) d θ ;$$
and
f) setting a reference current at each timestep in the dwell angle in accordance with the waveform shape and the time-based position estimate and scaled by the target magnitude.

2. The method of claim 1 wherein the desired waveform shape in the dwell region is programmed as a polynomial series based on Chebyshev polynomials.

3. The method of claim 1 wherein a series of polynomial coefficients [P₀ . . . Pₙ] is determined for describing the current waveform shape I(θ).

4. The method of claim 1 wherein the torque required to maintain the operating speed is estimated.

5. The method of claim 1 wherein the target magnitude M for a programmable dwell angle to scale the current waveform to produce the required torque is given by
$$M \approx \frac{T}{\frac{3}{2 π} {\int }_{n}^{2 n} K ( θ ) I ( θ ) d θ}$$

6. The method of claim 1 wherein the reference current is calculated as a function of the time-based estimated rotor position x by the function
I(x)=M(P₀+x(P₁+x(P₂+ . . . xPₙ)))

7. The method of claim 1 further comprising the step of utilizing a non-constant current profile to optimize performance based on desired criteria.

8. The method of claim 1 further comprising reducing the current to zero using a decay mechanism following the end of the dwell angle.

9. A method for sensorless current profiling of a switched-reluctance motor (SRM) to reduce acoustic noise and torque ripple, the method comprising the steps of:
a) providing a sensorless switched-reluctance motor control system comprising a switched-reluctance motor having at least one stator pole and at least one rotor pole, a phase inverter controlled by a processor, a load, a converter and a software control module at the processor;
b) estimating a time-based rotor position estimate at every commutation utilizing a time-based interpolation module at the processor;
c) determining a series of polynomial coefficients [P₀ . . . Pₙ] for describing a current waveform shape I(θ);
d) determining a current waveform shape that optimizes a motor performance objective function;
e) determining an optimum rise point at a turn-on time of the current waveform;
f) determining torque required to maintain the operating speed of the motor;
g) setting a target magnitude M for a programmable dwell angle to scale the current waveform as required to produce torque required to maintain a given speed according to the equation
$$M \approx \frac{T}{\frac{3}{2 π} {\int }_{n}^{2 n} K ( θ ) I ( θ ) d θ} ;$$
and
h) setting a reference current I_{ref} at each time step in the dwell angle in accordance with the waveform shape and the time-based position estimate and scaled by the target magnitude.

10. The method of claim 9 wherein the desired waveform shape in the dwell region is programmed as a polynomial series based on Chebyshev polynomials.

11. The method of claim 9 wherein the current waveform shape is a function of the time-based position estimate.

12. The method of claim 9 wherein the reference current is calculated as a function of the time-based estimated rotor position x by the function
I(x)=M(P₀+x(P₁+x(P₂+ . . . xPₙ)))

13. The method of claim 9 further comprising reducing acoustic noise by reducing overall radial force magnitude, reducing torque ripple by compensating for nonlinear torque production, and increasing efficiency by reducing peak flux in the machine at light loads.

14. The method of claim 9 further comprising utilizing a non-constant current profile to optimize performance based on desired criteria.

15. The method of claim 9 further comprising reducing the current to zero using a decay mechanism following the end of the dwell angle.

16. An apparatus for sensorless profiling of a current waveform in a switched-reluctance motor (SRM), comprising:
a switched-reluctance motor having at least one stator pole and at least one rotor pole;
a phase inverter controlled by a processor and connected to the switched-reluctance motor to provide power supply to the SRM, the processor having a software control module and a time-based interpolation estimation module;
a load connected to the switched-reluctance motor via an inline torque meter; and
a converter connected to the load;
whereby the time-based interpolation module estimates a position of the rotor and the software control module at the processor determines the shape of the current waveform to produce a torque required to maintain the motor operating speed and thereby reduce acoustic noise, torque ripple and increase efficiency utilizing a non-constant current profile.

17. The apparatus of claim 16 wherein the time-based interpolation module at the processor estimates the rotor position at every commutation.

18. The apparatus of claim 16 wherein the processor determines the rise point of the current waveform and the magnitude of current required to produce torque to control a given speed of the motor.

19. The apparatus of claim 16 wherein the apparatus provides a non-constant current profile to optimize performance based on desired criteria.

20. The apparatus of claim 16 wherein the apparatus allows control of waveform profiles of an arbitrary shape.
